(19) United States
(12) Patent Application Publication
(10) Pub. No.: US 2013/0090888 A1
(43) Pub. Date: Apr. 11, 2013

(54) System and method for proximity based thermal management of mobile device

(71) Applicants: Jon J. Anderson, Boulder, CO (US); Gary D. Good, San Diego, CA (US); James D. Burrell, San Diego, CA (US)

(72) Inventors: Jon J. Anderson, Boulder, CO (US); Gary D. Good, San Diego, CA (US); James D. Burrell, San Diego, CA (US)

(73) Assignee: QUALCOMM Incorporated, San Diego, CA (US)

(21) Appl. No.: 13/289,807

(22) Filed: Nov. 4, 2011

Related U.S. Application Data
(60) Provisional application No. 61/544,755, filed on Oct. 7, 2011.

(51) Int. Cl. G01K 13/00; G06F 15/00

(52) U.S. Cl. 702/130

(57) ABSTRACT

Various embodiments of methods and systems for leveraging a user proximity measurement to determine thermal management policies in a portable computing device (“PCD”) are disclosed. By leveraging the proximity measurement to set temperature thresholds, the quality of service (“QoS”) provided by the PCD can be optimized when touch temperature of the PCD is not a significant factor for user experience. One such method involves monitoring a proximity signal to determine relative physical proximity of the PCD to a user. Based on the user proximity, a temperature threshold associated with a temperature sensor may be set and compared with an actual temperature measurement received from the temperature sensor. Based on the comparison, thermal management policies in the PCD can be evaluated. For instance, if the temperature threshold is higher than the actual measurement, PCD components may be allowed to increase power consumption, even though PCD temperature may rise, thereby optimizing QoS.

### CROSS-REFERENCE TO RELATED APPLICATIONS

Priority under 35 U.S.C. §119(e) is claimed to the U.S. provisional application entitled “SYSTEM AND METHOD FOR PROXIMITY BASED THERMAL MANAGEMENT OF A MOBILE DEVICE,” filed on Oct. 7, 2011 and assigned application Ser. No. 61/544,755, the entire contents of which are hereby incorporated by reference.

### DESCRIPTION OF THE RELATED ART

Portable computing devices (“PCDs”) are becoming necessities for people on personal and professional levels. These devices may include cellular telephones, portable digital assistants (“PDAs”), portable game consoles, palmtop computers, and other portable electronic devices.

One unique aspect of PCDs is that they typically do not have active cooling devices, like fans, as are often found in larger computing devices such as laptop and desktop computers. Instead of using fans, PCDs may rely on strategic placement of passive cooling devices and/or spatial arrangement of electronic packaging so that two or more active and heat producing components are not positioned proximally to one another. When two or more heat producing components are suitably spaced from one another within a PCD, thermal energy generated from the operation of each component may not combine to cause temperatures that can negatively impact user experience.

The reality, however, is that PCDs are typically limited in size and, therefore, room for components within a PCD often comes at a premium. As such, there just typically isn't enough space within a PCD for engineers and designers to control temperature through spatial arrangements or placement of passive cooling components. Therefore, to reduce thermal energy generation within a PCD, engineers and designers often leverage one or more thermal mitigation techniques that essentially trade off PCD performance for a lower rate of thermal energy generation. Implementation of a thermal mitigation technique is usually triggered by temperature measurements within the PCD.

In most PCDs today, the trigger temperature for applying a thermal mitigation technique is linked to the “touch temperature” of the device and not the temperature of any given component within the PCD. That is, most PCDs today are capable of efficiently running at a temperature level that exceeds the temperature considered to be acceptable for contact with a user. Notably, therefore, PCD performance is often sacrificed unnecessarily by applying thermal mitigation techniques when the PCD is not proximal to a user.

Accordingly, what is needed in the art is a method and system for leveraging the proximity of a PCD to its user so that thermal energy generated by the PCD may be managed smartly without over-impacting its performance and functionality.

### SUMMARY OF THE DISCLOSURE

Various embodiments of methods and systems for leveraging a user proximity measurement to determine thermal management policies implemented in a portable computing device (“PCD”) are disclosed. Notably, in many PCDs, the “touch temperature” of the external surfaces of the device limits the extent to which the performance capabilities of the PCD can be exploited. Generally, as more power is consumed by the various components of a PCD, the resulting generation of thermal energy can cause the external temperatures of the PCD to detrimentally affect user experience.

Because the touch temperature of a PCD may be an insignificant factor for user experience when the PCD is not physically proximal to a user, one such method for determining thermal management policies based on a user proximity measurement involves monitoring a proximity signal from a proximity sensor in the PCD that is useful for indicating the relative physical proximity of the PCD to a user. Based on the monitored proximity signal, a first temperature threshold associated with a first temperature sensor may be set and then used for triggering initiation of one or more thermal management policies. Notably, the temperature sensor may be positioned within the PCD to measure any number of temperatures including, but not limited to, touch temperature, component operating temperature, etc.

The first temperature threshold may then be compared with an actual temperature measurement received from the first temperature sensor. Based on that comparison, the applicability of currently implemented thermal management policies in the PCD can be evaluated. For instance, if the temperature threshold is higher than the actual measurement, thermal management policies that allow one or more components to increase power consumption, even though more thermal energy will be generated and dissipated as a result, can be implemented and quality of service (“QoS”) increased. Similarly, if the temperature threshold is lower or near the actual temperature measurement, thermal mitigation techniques may be implemented to reduce the thermal energy generation, thereby causing QoS to suffer but improving user experience by lowering the temperature of the PCD.

Advantageously, as one of ordinary skill in the art will recognize, by leveraging a user proximity measurement to set temperature thresholds of the PCD, the QoS provided by the PCD can be optimized when touch temperature of the PCD is not a significant factor for user experience.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a functional block diagram illustrating an embodiment of an on-chip system for implementing proximity based thermal management in a portable computing device (“PCD”);

FIG. 2 is a functional block diagram illustrating an exemplary, non-limiting aspect of the PCD of FIG. 1 in the form of a wireless telephone for implementing methods and systems for monitoring thermal conditions, adjusting temperature thresholds based on user proximity and triggering application of thermal mitigation measures based on the adjusted thresholds;

FIG. 3A is a functional block diagram illustrating an exemplary spatial arrangement of hardware for the chip illustrated in FIG. 2;

FIG. 3B is a schematic diagram illustrating an exemplary software architecture of the PCD of FIG. 2 for proximity based thermal management;

FIG. 4 is a is an exemplary state diagram that illustrates various proximity based policy states that may trigger temperature thresholds set by the specific absorption rate module in the PCD of FIG. 1;

FIG. 5 is a diagram illustrating exemplary thermal management policies and associated conditions that may be leveraged by the thermal policy manager module in FIG. 1 and are dependent upon a particular proximity state illustrated in FIG. 4;

FIG. 6 is a logical flowchart illustrating a method for managing one or more thermal policies based on an indication of user proximity; and

FIG. 7 is a logical flowchart illustrating a sub-method or subroutine for applying thermal management policies.

### DETAILED DESCRIPTION

The word “exemplary” is used herein to mean “serving as an example, instance, or illustration.” Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” “thermal energy generating component,” “processing component” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” “graphical processing unit (“GPU”),” and “chip” are used interchangeably. Moreover, a CPU, DSP, GPU or a chip may be comprised of one or more distinct processing components generally referred to herein as “core(s).” Additionally, to the extent that a CPU, DSP, GPU, chip or core is a functional component within a PCD that consumes various levels of power to operate at various levels of functional efficiency, one of ordinary skill in the art will recognize that the use of these terms does not limit the application of the disclosed embodiments, or their equivalents, to the context of processing components within a PCD. That is, although many of the embodiments are described in the context of a processing component, it is envisioned that thermal policies triggered by proximity measurements may be applied to any functional component within a PCD including, but not limited to, a modem, a camera, a wireless network interface controller (“WNIC”), a display, a video encoder, a peripheral device, etc.

In this description, it will be understood that the terms “thermal” and “thermal energy” may be used in association with a device or component capable of generating or dissipating energy that can be measured in units of “temperature.” Consequently, it will further be understood that the term “temperature,” with reference to some standard value, envisions any measurement that may be indicative of the relative warmth, or absence of heat, of a “thermal energy” generating device or component. For example, the “temperature” of two components is the same when the two components are in “thermal” equilibrium.

In this description, the terms “workload,” “process load” and “process workload” are used interchangeably and generally directed toward the processing burden, or percentage of processing burden, associated with a given processing component in a given embodiment. Further to that which is defined above, a “processing component” or “thermal energy generating component” or “thermal aggressor” may be, but is not limited to, a central processing unit, a graphical processing unit, a core, a main core, a sub-core, a processing area, a hardware engine, etc. or any component residing within, or external to, an integrated circuit within a portable computing device. Moreover, to the extent that the terms “thermal load,” “thermal distribution,” “thermal signature,” “thermal processing load” and the like are indicative of workload burdens that may be running on a thermal aggressor, one of ordinary skill in the art will acknowledge that use of these “thermal” terms in the present disclosure may be related to process load distributions, workload burdens and power consumption.

In this description, the terms “thermal mitigation technique(s),” “thermal policies,” “thermal management,” “thermal mitigation measure(s)” and “throttling strategy” are used interchangeably. Notably, one of ordinary skill in the art will recognize that, depending on the particular context of use, any of the terms listed in this paragraph may serve to describe hardware and/or software operable to increase performance at the expense of thermal energy generation, decrease thermal energy generation at the expense of performance, or alternate between such goals.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, among others.

Managing thermal energy generation in a PCD, without unnecessarily impacting quality of service (“QoS”), can be accomplished by leveraging one or more sensor measurements that indicates proximity of the PCD to its user. Advantageously, many PCDs already include a proximity sensor and associated hardware and/or software for managing the specific absorption rate (“SAR”) of radio frequency (“RF”) signals, such as wireless local area network (“WLAN”) signals and cellular telephone network signals, by a user. This SAR hardware and/or software is leveraged in some embodiments to detect if the PCD has been positioned within close proximity of a user, such as adjacent to the user's head, legs or lap, as a trigger for determining and applying thermal management policies within the PCD.

Notably, although it is envisioned that embodiments may leverage an existing SAR module in a PCD, it is also envisioned that some embodiments may include one or more proximity sensors dedicated for the purpose of triggering thermal management policies within the PCD. Moreover, although embodiments described herein primarily leverage the proximity measurements of an existing SAR module within a PCD to determine the relative proximity of an entire PCD to its user, it is also envisioned that multiple proximity sensors may be leveraged in some embodiments to determine portions of the PCD that are in contact with the user. That is, it is envisioned that some embodiments may leverage proximity sensors within a PCD to map the location of a user's contact on the PCD and apply thermal management policies to components within the PCD which may affect the touch temperature at such mapped locations of user contact. As such, even though the particular exemplary embodiments described in this specification refer to a proximity measurement taken from a single proximity sensor sensing relative proximity of an entire PCD to its user, it will understood that such reference includes embodiments and envisions embodiments that leverage multiple proximity measurements and/or fine grained proximity determinations.

While the SAR hardware/software (i.e., SAR module) may be used to adjust RF output of the PCD or disable the user interface when the PCD is proximal to a user, in embodiments of the system and method for proximity based thermal management it may also be used by the PCD for triggering throttling strategies that optimize PCD performance subject to acceptable temperature ranges for user contact (or lack of user contact). As generally described above, throttling strategies are various methods, applications and/or algorithms that may be employed by the PCD to increase its performance through adjustment of hardware and/or software parameters, such as the clock speed of a central processing unit (“CPU”) or the like. Certain throttling strategies may increase performance of a PCD at the expense of increased thermal energy generation; however, certain other throttling strategies may mitigate a detrimental rise in operating temperature by reducing PCD performance.

In various embodiments, the SAR module may be used by the PCD to dictate the application of certain throttling strategies that increase the performance efficiency of the PCD when it is not in direct contact or in close proximity to a user. Conversely, embodiments may also leverage the SAR module to trigger the implementation of throttling strategies that operate to prevent the PCD from generating heat above temperature thresholds that are acceptable for human contact.

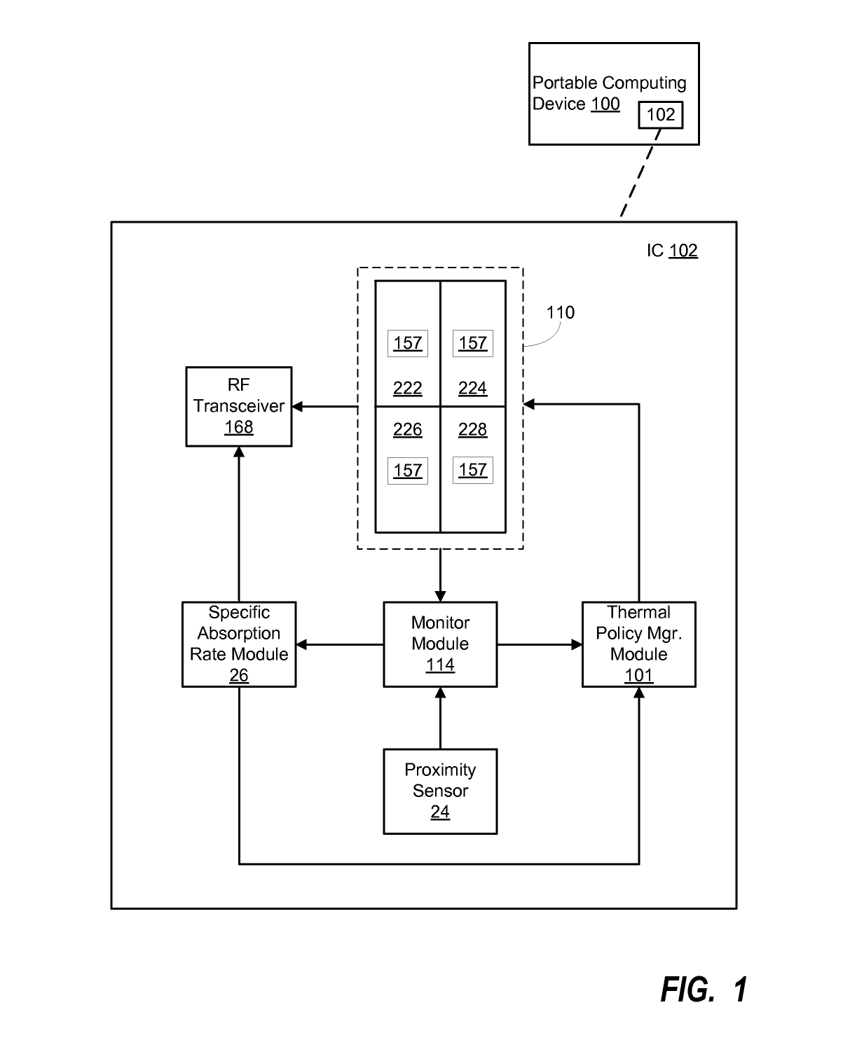

FIG. 1 is a functional block diagram illustrating an exemplary embodiment of an on-chip system 102 for proximity based thermal management in a portable computing device 100. To set temperature thresholds for triggering the application of one or more thermal mitigation techniques, the on-chip system 102 may leverage various sensors 24, 157 for detecting proximity of the PCD 100 to a user and measuring temperatures associated with processing components 110. Advantageously, by defining and updating acceptable temperature thresholds based on proximity of the PCD 100 to a user, the QoS experienced by a user of the PCD may be optimized by avoiding unnecessary throttling of the CPU 110 triggered by preset, over-restrictive temperature thresholds.

In general, the system employs two main modules which, in some embodiments, may be contained in a single module: (1) a SAR module 26 for determining the PCD's state of proximity to a user and adjusting temperature thresholds; and (2) a thermal policy manager (“TPM”) module 101 for implementing throttling strategies based on the temperature threshold set by the SAR module. Advantageously, embodiments of the system and method that include the two main modules leverage user proximity data to capitalize on opportunities for processing components 110 within the PCD 100 to consume more power, and thus generate more thermal energy, when the touch temperature, i.e. the outer temperature of the PCD 100 exposed to a user, is not a significant factor of user experience.

In some exemplary PCDs 100, the SAR module 26 may be in communication with an RF transceiver 168 and configured to adjust RF output of the transceiver 168 when the PCD 100 is near a user. To recognize a state of user proximity, the SAR module 26 may receive a signal from a monitor module 114 that is in communication with a proximity sensor 24. As is understood by one of ordinary skill in the art, a proximity sensor 24 may be able to detect the proximal presence of a user with and/or without the user physically contacting the PCD 100.

Some embodiments of a proximity sensor 24 may be configured to emit an electromagnetic field and recognize a disturbance in the field that indicates user proximity to the PCD 100. Similarly, other proximity sensor embodiments 24 may generate an electromagnetic transmission (e.g., infrared) and recognize a return transmission that reflects from a proximal user. Still other embodiments of a proximity sensor 24 may leverage gyroscopes or accelerometers to deduce a user's presence based on movement of the PCD 100. Notably, although it is envisioned that certain proximity sensor technologies and/or algorithms that may be used by various embodiments to determine or deduce relative proximity of a user to a PCD 100 may be novel in and of themselves, it will be understood that embodiments of the system and method are not limited to any particular proximity sensor technology or methodology.

Returning to the FIG. 1 illustration, the SAR module 26 may receive a signal generated by the proximity sensor 24 that indicates the PCD 100 is not proximal to a user. Notably, because the PCD 100 is not physically near a user, the touch temperature of the PCD 100 is not a significant factor of user experience in the short term. As such, even though increased thermal energy dissipation may cause the touch temperature of the PCD 100 to exceed a default threshold deemed acceptable for user exposure, the various processing cores 222, 224, 226, 228 of the multi-core processing component 110 may increase processing capacity to provide a higher QoS because the touch temperature threshold is not a primary determinant for acceptable levels of thermal energy generation in the immediate short term.

Returning to the exemplary scenario of a proximity state that indicates the user is physically away from the PCD 100, the SAR module 26 may communicate with the TPM module 101 to override or adjust a default temperature threshold associated with acceptable touch temperature of the PCD 100. In adjusting the temperature threshold, the SAR module 26 may set a new, higher temperature threshold associated with temperature limits of one or more components of the PCD 100. Subsequently, the TPM module 101 may receive temperature readings from the monitor module 114 indicating temperature levels sensed by sensors 157 which may be associated individually or collectively with one or more various processing components 222, 224, 226, 228. Based on the temperature readings from sensors 157 and the new, higher temperature threshold set by the SAR module 26, the TPM 101 may implement thermal management techniques to optimize processing performance in view of thermal energy dissipation.

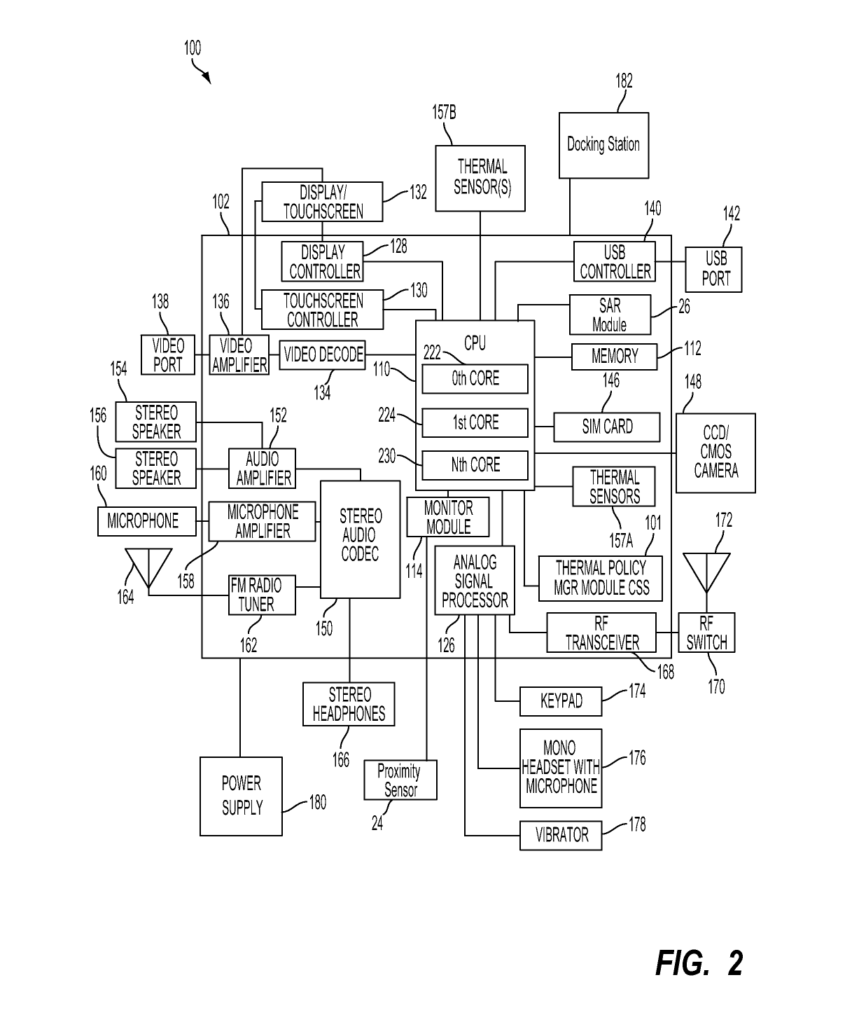

FIG. 2 is a functional block diagram of an exemplary, non-limiting aspect of a PCD 100 in the form of a wireless telephone for implementing methods and systems for monitoring thermal conditions, adjusting temperature thresholds based on user proximity and triggering application of thermal mitigation measures based on the adjusted thresholds. As shown, the PCD 100 includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) may also be employed as understood by one of ordinary skill in the art.

In general, the TPM module(s) 101 may be responsible for monitoring and applying thermal policies that may help a PCD 100 manage thermal conditions and/or thermal loads and avoid experiencing adverse thermal conditions, such as, for example, reaching critical temperatures, while maintaining a high level of functionality.

FIG. 2 also shows that the PCD 100 may include a monitor module 114. The monitor module 114 communicates with multiple operational sensors (e.g., thermal sensors 157) distributed throughout the on-chip system 102 and with the CPU 110 of the PCD 100 as well as with the TPM module 101. In some embodiments, monitor module 114 may also monitor signals generated by proximity sensor 24 and transmit the signal, or data representative of the signal, to the SAR module 26. The TPM module 101 may work with the monitor module 114 to identify adverse thermal conditions relative to temperature thresholds set by SAR module 26 and apply one or more thermal mitigation techniques to manage thermal aggressors within chip 102.

As illustrated in FIG. 2, a display controller 128 and a touch screen controller 130 are coupled to the digital signal processor 110. A touch screen display 132 external to the on-chip system 102 is coupled to the display controller 128 and the touch screen controller 130.

PCD 100 may further include a video encoder 134, e.g., a phase-alternating line (“PAL”) encoder, a sequential couleur avcc memoire (“SECAM”) encoder, a national television system(s) committee (“NTSC”) encoder or any other type of video encoder 134. The video encoder 134 is coupled to the multi-core central processing unit (“CPU”) 110. A video amplifier 136 is coupled to the video encoder 134 and the touch screen display 132. A video port 138 is coupled to the video amplifier 136. As depicted in FIG. 2, a universal serial bus (“USB”) controller 140 is coupled to the CPU 110. Also, a USB port 142 is coupled to the USB controller 140. A memory 112 and a subscriber identity module (“SIM”) card 146 may also be coupled to the CPU 110. Further, as shown in FIG. 2, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 2, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 2 shows that a microphone amplifier 158 may be also coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 2 further indicates that a radio frequency (“RF”) transceiver 168 may be coupled to the analog signal processor 126. An RF switch 170 may be coupled to the RF transceiver 168 and an RF antenna 172. As shown in FIG. 2, a keypad 174 may be coupled to the analog signal processor 126. Also, a mono headset with a microphone 176 may be coupled to the analog signal processor 126. Further, a vibrator device 178 may be coupled to the analog signal processor 126. FIG. 2 also shows that a power supply 180, for example a battery, is coupled to the on-chip system 102. In a particular aspect, the power supply includes a rechargeable DC battery or a DC power supply that is derived from an alternating current (“AC”) to DC transformer that is connected to an AC power source.

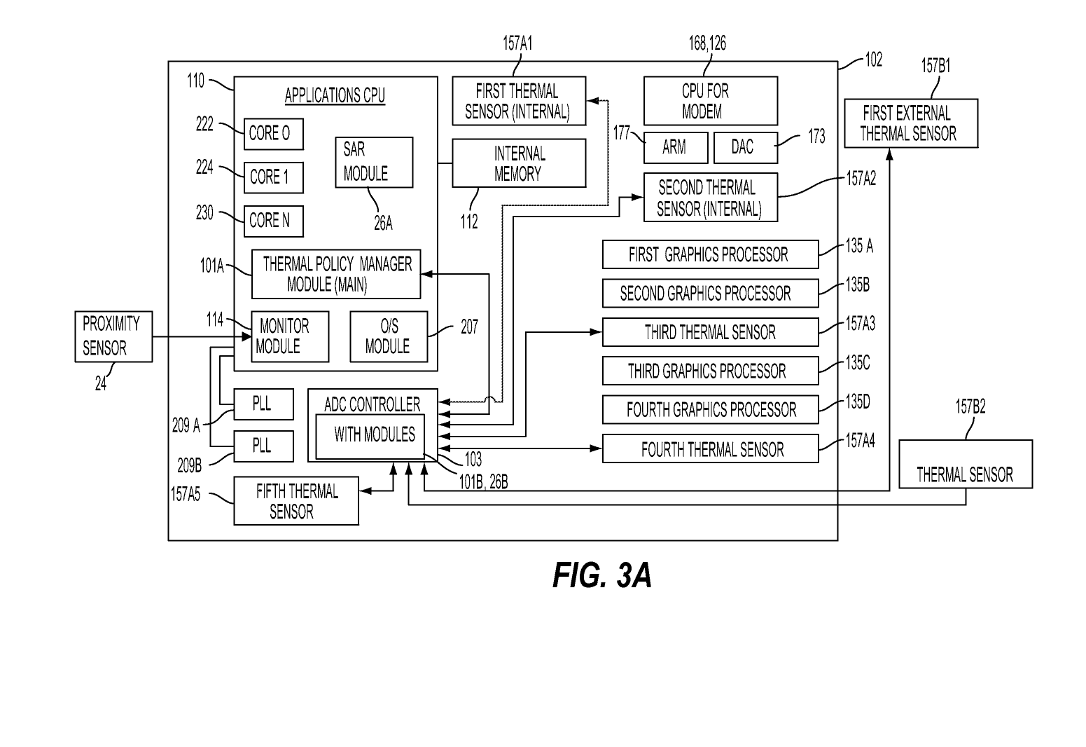

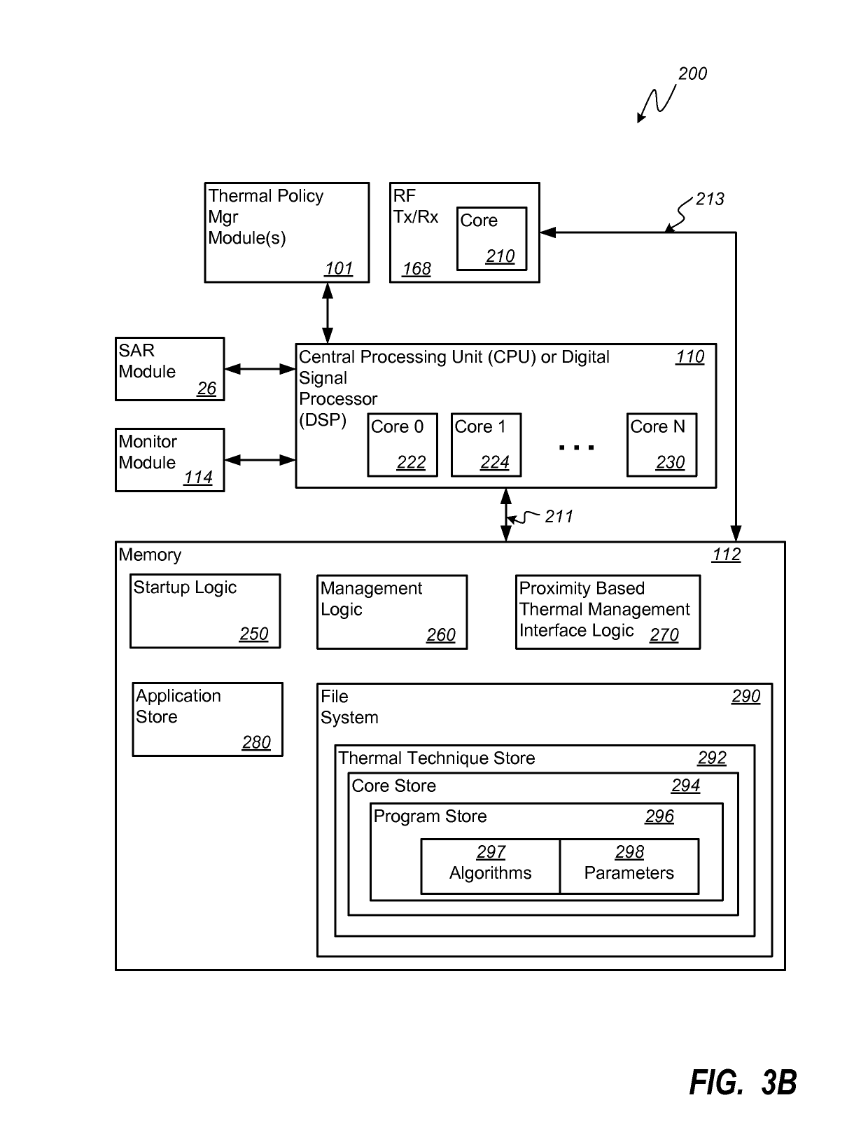

The CPU 110 may also be coupled to one or more internal, on-chip thermal sensors 157A as well as one or more external, off-chip thermal sensors 157B. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157B may comprise one or more thermistors. The thermal sensors 157 may produce a voltage drop that is converted to digital signals with an analog-to-digital converter (“ADC”) controller 103 (See FIG. 3A). However, other types of thermal sensors 157 may be employed without departing from the scope of the invention.

The thermal sensors 157, in addition to being controlled and monitored by an ADC controller 103, may also be controlled and monitored by one or more TPM module(s) 101. The TPM module(s) may comprise software which is executed by the CPU 110. However, the TPM module(s) 101 may also be formed from hardware and/or firmware without departing from the scope of the invention. The TPM module(s) 101 may be responsible for monitoring and applying thermal policies that may be triggered by any combination of signals generated by the sensors 157, 24. For instance, TPM module(s) 101, in some embodiments, may compare operating temperatures measured by sensors 157A with a temperature threshold determined from a proximity signal generated by proximity sensor 24 and apply a thermal management policy based on the comparison. In other embodiments, the TPM module(s) 101 may compare a “touch temperature” measurement taken by a sensor 157B and with a temperature threshold determined from a proximity signal generated by proximity sensor 24 and apply a thermal management policy based on the comparison that serves to mitigate thermal energy generation. Notably, the application of thermal management and/or mitigation policies by the TPM module(s) 10 may help a PCD 100 avoid critical temperatures while maintaining a high level of functionality.

Similarly, the SAR module(s) 26 may comprise software which is executed by the CPU 110. However, the SAR module(s) 26 may also be formed from hardware and/or firmware without departing from the scope of the invention.

Returning to FIG. 2, the touch screen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, thermal sensors 157B, proximity sensor 24 and the power supply 180 are external to the on-chip system 102. However, it should be understood that the monitor module 114 may also receive one or more indications or signals from one or more of these external devices by way of the analog signal processor 126 and the CPU 110 to aid in the real time management of the resources operable on the PCD 100. Further, it will be understood that one or more of these devices depicted as external to the on-chip system 102 in the exemplary embodiment of a PCD 100 in FIG. 2 may reside on chip 102 in other exemplary embodiments. The docking station 182 is depicted as being off-chip, however, it will be understood by one of ordinary skill in the art that a docking station 182 may be in communication with the chip 102 only when the PCD 100 is physically received by the docking station 182. Further, as one of ordinary skill in the art will recognize, a docking station 182 may be configured to received a PCD 100 such that one or more external devices such as, but not limited to, a keyboard, monitor, mouse, printer, etc. may be leveraged by the PCD 100 for the benefit of its user.

In a particular aspect, one or more of the method steps described herein may be implemented by executable instructions and parameters stored in the memory 112 that form the one or more TPM module(s) 101 and SAR module(s) 26. These instructions that form the TPM module(s) 101 and SAR module(s) 26 may be executed by the CPU 110, the analog signal processor 126, or another processor, in addition to the ADC controller 103 to perform the methods described herein. Further, the processors 110, 126, the memory 112, the instructions stored therein, or a combination thereof may serve as a means for performing one or more of the method steps described herein.

FIG. 3A is a functional block diagram illustrating an exemplary spatial arrangement of hardware for the chip 102 illustrated in FIG. 2. According to this exemplary embodiment, the applications CPU 110 is positioned on the far left side region of the chip 102 while the modem CPU 168, 126 is positioned on a far right side region of the chip 102. The applications CPU 110 may comprise a multi-core processor that includes a zeroth core 222, a first core 224, and an Nth core 230. The applications CPU 110 may be executing a TPM module 101A and/or SAR module 26A (when embodied in software) or it may include a TPM module 101A and/or SAR module 26A (when embodied in hardware). The application CPU 110 is further illustrated to include operating system (“O/S”) module 207 and a monitor module 114. Further details about the monitor module 114 will be described below in connection with FIG. 3B.

The applications CPU 110 may be coupled to one or more phase locked loops (“PLLs”) 209A, 209B, which are positioned adjacent to the applications CPU 110 and in the left side region of the chip 102. Adjacent to the PLLs 209A, 209B and below the applications CPU 110 may comprise an analog-to-digital (“ADC”) controller 103 that may include its own thermal policy manager 101B and/or SAR module 26B that works in conjunction with the main modules 101A, 26A of the applications CPU 110.

The thermal policy manager 101B of the ADC controller 103 may be responsible for monitoring and tracking multiple thermal sensors 157 that may be provided “on-chip” 102 and “off-chip” 102. The on-chip or internal thermal sensors 157A may be positioned at various locations and associated with thermal aggressor(s) proximal to the locations.

As a non-limiting example, a first internal thermal sensor 157A1 may be positioned in a top center region of the chip 102 between the applications CPU 110 and the modem CPU 168,126 and adjacent to internal memory 112. A second internal thermal sensor 157A2 may be positioned below the modem CPU 168, 126 on a right side region of the chip 102. This second internal thermal sensor 157A2 may also be positioned between an advanced reduced instruction set computer (“RISC”) instruction set machine (“ARM”) 177 and a first graphics processor 135A. A digital-to-analog controller (“DAC”) 173 may be positioned between the second internal thermal sensor 157A2 and the modem CPU 168, 126.

A third internal thermal sensor 157A3 may be positioned between a second graphics processor 135B and a third graphics processor 135C in a far right region of the chip 102. A fourth internal thermal sensor 157A4 may be positioned in a far right region of the chip 102 and beneath a fourth graphics processor 135D. And a fifth internal thermal sensor 157A5 may be positioned in a far left region of the chip 102 and adjacent to the PLLs 209 and ADC controller 103.

One or more external thermal sensors 157B may also be coupled to the ADC controller 103. The first external thermal sensor 157B1 may be positioned off-chip and adjacent to a top right quadrant of the chip 102 that may include the modem CPU 168, 126, the ARM 177, and DAC 173. A second external thermal sensor 157B2 may be positioned off-chip and adjacent to a lower right quadrant of the chip 102 that may include the third and fourth graphics processors 135C, 135D. Notably, one or more of external thermal sensors 157B may be leveraged to indicate the touch temperature of the PCD 100, i.e. the temperature that may be experienced by a user in contact with the PCD 100.

One of ordinary skill in the art will recognize that various other spatial arrangements of the hardware illustrated in FIG. 3A may be provided without departing from the scope of the invention. FIG. 3A illustrates yet one exemplary spatial arrangement and how the main TPM and SAR modules 101A, 26A and ADC controller 103 with its TPM and SAR modules 101B, 26B may recognize thermal conditions that are a function of the exemplary spatial arrangement illustrated in FIG. 3A, compare temperature thresholds dictated by user proximity states with operating temperatures and/or touch temperatures and apply thermal management policies.

FIG. 3B is a schematic diagram illustrating an exemplary software architecture of the PCD 100 of FIG. 2 and FIG. 3A for supporting application of thermal management policies based on temperature thresholds dictated by the recognition of PCD 100 proximity, or lack thereof, to a user. Any number of algorithms may form or be part of at least one thermal management policy that may be applied by the thermal policy manager 101 when certain thermal conditions are met.

As illustrated in FIG. 3B, the CPU or digital signal processor 110 is coupled to the memory 112 via a bus 211. The CPU 110, as noted above, is a multiple-core processor having N core processors. That is, the CPU 110 includes a first core 222, a second core 224, and an N^{th} core 230. As is known to one of ordinary skill in the art, each of the first core 222, the second core 224 and the N^{th} core 230 are available for supporting a dedicated application or program. Alternatively, one or more applications or programs can be distributed for processing across two or more of the available cores.

The CPU 110 may receive commands from the TPM module(s) 101 that may comprise software and/or hardware. If embodied as software, the TPM module 101 comprises instructions that are executed by the CPU 110 that issues commands to other application programs being executed by the CPU 110 and other processors.

The first core 222, the second core 224 through to the Nth core 230 of the CPU 110 may be integrated on a single integrated circuit die, or they may be integrated or coupled on separate dies in a multiple-circuit package. Designers may couple the first core 222, the second core 224 through to the N^{th} core 230 via one or more shared caches and they may implement message or instruction passing via network topologies such as bus, ring, mesh and crossbar topologies.

In the illustrated embodiment, the RF transceiver 168 is implemented via digital circuit elements and includes at least one processor such as the core processor 210 (labeled “Core”). In this digital implementation, the RF transceiver 168 is coupled to the memory 112 via bus 213.

Each of the bus 211 and the bus 213 may include multiple communication paths via one or more wired or wireless connections, as is known in the art. The bus 211 and the bus 213 may have additional elements, which are omitted for simplicity, such as controllers, buffers (caches), drivers, repeaters, and receivers, to enable communications. Further, the bus 211 and the bus 213 may include address, control, and/or data connections to enable appropriate communications among the aforementioned components.

When the logic used by the PCD 100 is implemented in software, as is shown in FIG. 3B, it should be noted that one or more of startup logic 250, management logic 260, proximity based thermal management interface logic 270, applications in application store 280 and portions of the file system 290 may be stored on any computer-readable medium for use by, or in connection with, any computer-related system or method.

In the context of this document, a computer-readable medium is an electronic, magnetic, optical, or other physical device or means that can contain or store a computer program and data for use by or in connection with a computer-related system or method. The various logic elements and data stores may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, for instance via optical scanning of the paper or other medium, then compiled, interpreted or otherwise processed in a suitable manner if necessary, and then stored in a computer memory.

In an alternative embodiment, where one or more of the startup logic 250, management logic 260 and perhaps the proximity based thermal management interface logic 270 are implemented in hardware, the various logic may be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The memory 112 is a non-volatile data storage device such as a flash memory or a solid-state memory device. Although depicted as a single device, the memory 112 may be a distributed memory device with separate data stores coupled to the digital signal processor and or the core 210 (or additional processor cores) in the RF transceiver 168.

The startup logic 250 includes one or more executable instructions for selectively identifying, loading, and executing a select program for managing or controlling the performance of one or more of the available cores such as the first core 222, the second core 224 through to the N^{th} core 230. The startup logic 250 may identify, load and execute a select program based on the comparison, by the TPM module 101, of various temperature measurements with threshold temperature settings associated with a proximity state. An exemplary select program can be found in the program store 296 of the embedded file system 290 and is defined by a specific combination of a performance scaling algorithm 297 and a set of parameters 298. The exemplary select program, when executed by one or more of the core processors in the CPU 110 and the core 210 in the RF transceiver 168, may operate in accordance with one or more signals provided by the monitor module 114 in combination with control signals provided by the one or more TPM module(s) 101 to scale the performance of the respective processor core “up” or “down.” In this regard, the monitor module 114 may provide one or more indicators of events, processes, applications, resource status conditions, elapsed time, as well as temperature as received from the TPM module 101.

The management logic 260 includes one or more executable instructions for terminating a thermal management program on one or more of the respective processor cores, as well as selectively identifying, loading, and executing a more suitable replacement program for managing or controlling the performance of one or more of the available cores. The management logic 260 is arranged to perform these functions at run time or while the PCD 100 is powered and in use by an operator of the device. A replacement program can be found in the program store 296 of the embedded file system 290 and, in some embodiments, may be defined by a specific combination of a performance scaling algorithm 297 and a set of parameters 298.

The replacement program, when executed by one or more of the core processors in the digital signal processor or the core 210 in the RF transceiver 168, may operate in accordance with one or more signals provided by the monitor module 114 or one or more signals provided on the respective control inputs of the various processor cores to scale the performance of the respective processor core. In this regard, the monitor module 114 may provide one or more indicators of events, processes, applications, resource status conditions, elapsed time, temperature, etc in response to control signals originating from the TPM 101.

The interface logic 270 includes one or more executable instructions for presenting, managing and interacting with external inputs to observe, configure, or otherwise update information stored in the embedded file system 290. In one embodiment, the interface logic 270 may operate in conjunction with manufacturer inputs received via the USB port 142. These inputs may include one or more programs to be deleted from or added to the program store 296. Alternatively, the inputs may include edits or changes to one or more of the programs in the program store 296. Moreover, the inputs may identify one or more changes to, or entire replacements of one or both of the startup logic 250 and the management logic 260. By way of example, the inputs may include a change to the management logic 260 that instructs the PCD 100 to suspend all performance scaling in the RF transceiver 168 when the received signal power falls below an identified threshold. By way of further example, the inputs may include a change to the management logic 260 that instructs the PCD 100 to apply a desired program when the video codec 134 is active.

The interface logic 270 enables a manufacturer to controllably configure and adjust an end user's experience under defined operating conditions on the PCD 100. When the memory 112 is a flash memory, one or more of the startup logic 250, the management logic 260, the interface logic 270, the application programs in the application store 280 or information in the embedded file system 290 can be edited, replaced, or otherwise modified. In some embodiments, the interface logic 270 may permit an end user or operator of the PCD 100 to search, locate, modify or replace the startup logic 250, the management logic 260, applications in the application store 280 and information in the embedded file system 290. The operator may use the resulting interface to make changes that will be implemented upon the next startup of the PCD 100. Alternatively, the operator may use the resulting interface to make changes that are implemented during run time.

The embedded file system 290 includes a hierarchically arranged thermal technique store 292. In this regard, the file system 290 may include a reserved section of its total file system capacity for the storage of information for the configuration and management of the various parameters 298 and thermal management algorithms 297 used by the PCD 100. As shown in FIG. 3B, the store 292 includes a core store 294, which includes a program store 296, which includes one or more thermal management programs.

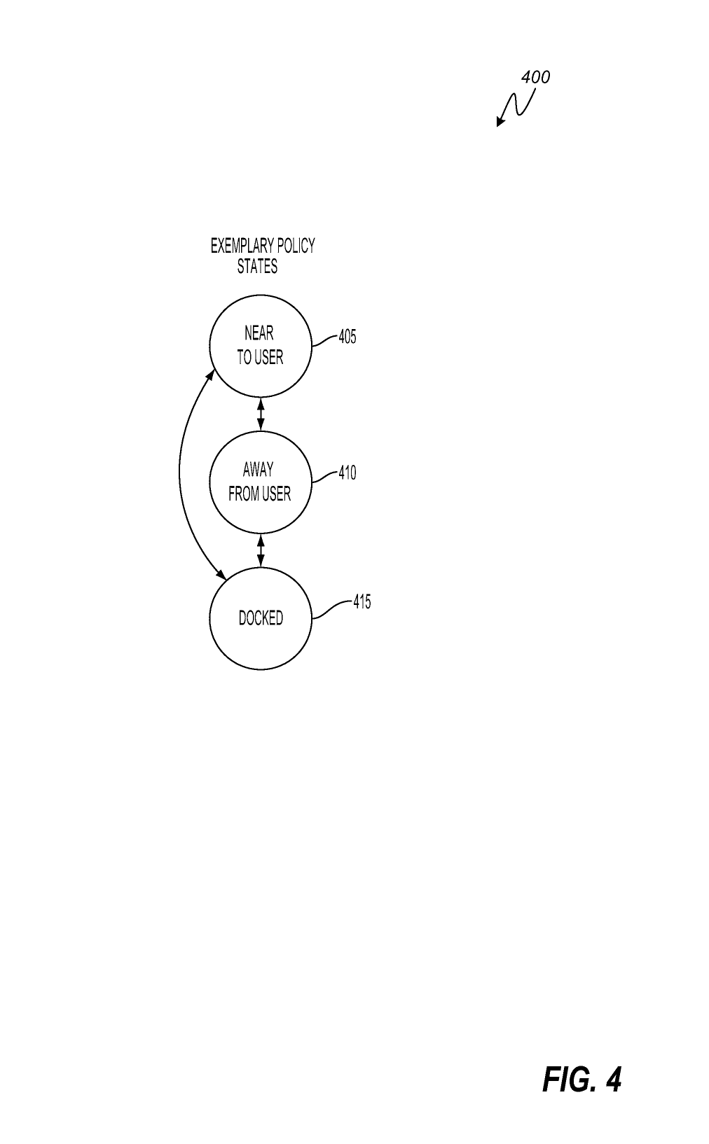

FIG. 4 is an exemplary proximity policy state diagram 400 that illustrates various user proximity states 405, 410 and 415 that are tracked by the thermal policy manager 101. The first policy state 405 may comprise a “near to user” state in which the SAR module 26 recognizes from the proximity sensor 24 that the PCD 100 is near, or in contact with, a user. Notably, in the near to user state 405, the touch temperature of the PCD 100, as may be indicated by an off-chip sensor 157B, is leveraged by the thermal policy manager 101 to determine thermal management policies suitably for maintaining the touch temperature below a predefined temperature threshold. In some embodiments, the touch temperature threshold may be the default temperature threshold that is leveraged by the TPM module 101 to manage thermal energy generation. The TPM 101 may monitor any, or a combination of, thermal sensors 157 to measure or derive the touch temperature of PCD 100 prior to applying, maintaining or terminating a thermal management policy.

In this exemplary near to user state 405, the PCD 100 is usually not in any danger or risk of reaching critical temperatures that may cause failure of any of the hardware and/or software components because the touch temperature is commonly significantly less than the operating temperature limits of the components within PCD 100. In this exemplary state, the thermal sensors 157 may be detecting or tracking temperatures that indicate a touch temperature at or below about 20° C. above ambient. However, one of ordinary skill in the art will recognize that other temperature ranges may be established for the near to user state 405 without departing from the scope of the invention.

The second policy state 410 may comprise an “away from user” state 410 in which the SAR module 26 recognizes from the proximity sensor 24 that the PCD 100 is not proximal to a user. Notably, in the away from user state 410, temperatures associated with one or more processing components of the PCD 100, as may be indicated by an on-chip sensor 157A or correlated with a measurement by an off-chip sensor 157B, is leveraged by the thermal policy manager 101 to determine thermal management policies suitable for optimizing processing performance without exceeding operating temperature thresholds of the various processing components. Advantageously, in the away from user state 410, the touch temperature of the PCD 100 may be allowed to exceed the temperature threshold described above relative to state 405, as the PCD 100 is not in immediate proximity to a user. As such, the TPM module 101 may implement thermal management policies that allow the various processing components to increase performance, thereby increasing QoS, even though thermal energy generation associated with the increased performance may cause the touch temperature to exceed its normal target threshold.

It is envisioned that, in some embodiments, the away from user state 410 may include a temperature threshold that exceeds the default touch temperature threshold described above but is less than the maximum operating temperature of the various processing components. In this way, subject to the temperature threshold set by the SAR module 26 when the PCD 100 is in the policy state 410, the TPM module 101 may apply thermal management policies that provide for increased processing performance without dissipating thermal energy at a rate that may cause the touch temperature to become unbearable should the PCD 100 reenter policy state 405 when a user “picks it up.” That is, in policy state 410, the default touch temperature threshold may be adjusted by the SAR module 26 to allow for increased processing performance without causing the PCD 100 to become so hot that thermal energy can't be quickly dissipated upon reentry into the near to user policy state 405.

The temperature threshold set by the SAR module 26 when the PCD 100 is recognized to be in policy state 410 may be associated with an adjusted touch temperature or, alternatively, may be associated with an acceptable operating temperature of one or more processing components. In either case, the TPM module 101 may leverage any, or a combination of, measurements taken by sensors 157 prior to applying, maintaining or terminating a thermal management policy based on the temperature threshold set by SAR module 26.

As will be understood by one of ordinary skill in the art, this exemplary away from user state 410 may be reached or entered into by the thermal policy manager 101 when a change of user proximity has been detected relative to states 405 and 415. In the second, away from user state 410 the TPM module 101 may request or it may actually perform one or more thermal management techniques in order to increase the processing performance, and consequently the temperature as well, of the PCD 100. In this particular state 410, the thermal policy manager 101 is designed to implement or request thermal mitigation techniques that may significantly increase the quality of service provided by the PCD 100 to a user, at the expense of increasing the touch temperature of the PCD 100. The temperature range for the operating temperature of one or more processing components in this second, away from user proximity state 410 may comprise a range between about 25° C. above ambient to about 40° C. above ambient. One of ordinary skill in the art will recognize, however, that other temperature ranges may be established for the policy state 410 and are within the scope of the invention.

The third policy state 415 may comprise a “docked” state in which the PCD 100 has been received by a docking station 182 or other hardware device configured to allow the PCD 100 to communicate with one or more external devices such as, but not limited to, a keyboard, a monitor, a mouse, a printer, etc. In some embodiments, a docking station or other peripheral device may include mechanical interface aspects that contribute to the efficiency of thermal energy dissipation from the PCD 100. Notably, when a PCD 100 is docked the SAR module 26 may recognize that the PCD 100 is not only physically separated from a user but also received by the docking station and unlikely to be physically contacted by a user. As such, when the PCD 100 is recognized as being in the docked state 415, the SAR module 26 may set temperature thresholds such that the TPM module 101 may apply thermal management policies that allow the processing components 110 and/or other components of the PCD 100 to run at high rates of power consumption. Advantageously, because the PCD 100 is in communication with a docking station 182, the SAR module 26 may recognize that performance efficiency is a more significant factor for user experience than touch temperature and, accordingly, set temperature thresholds that trigger the TPM module 101 to implement thermal management policies geared for optimizing PCD performance at the expense of thermal energy generation. The temperature range for threshold temperatures of various components when the PCD 100 is in this third, docked state 415 may comprise a range limited only by a maximum temperature specified for a brief touch (e.g., 95° C. for plastic surfaces per UL 60950), although other limits are envisioned to be within the scope of the disclosure.

As one of ordinary skill in the art will recognize, any of the various proximity policy states may be initiated based upon the change in proximity to a user, as detected by the proximity sensor 24 and recognized by the SAR module 26. For example, as the arrows in this diagram illustrate, each policy state may be initiated in sequence or they can be initiated out of sequence depending upon the change in proximity to a user.

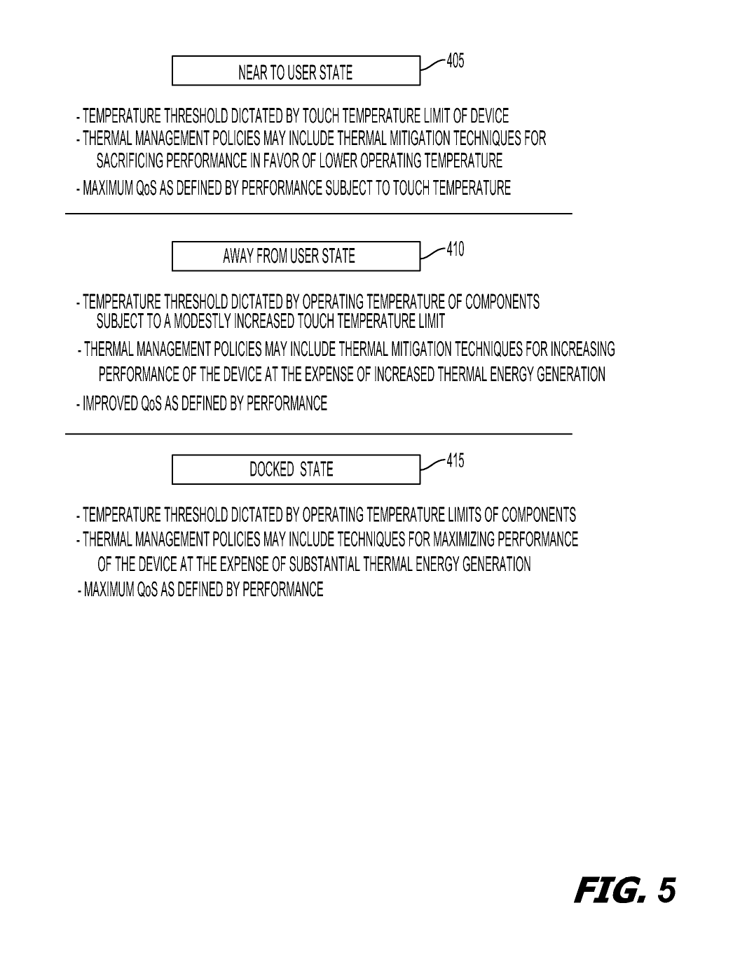

FIG. 5 is a diagram illustrating exemplary thermal management policies and associated conditions that may be leveraged by the thermal policy manager 101 and are dependent upon a particular proximity state of a PCD 100. As noted previously, the first proximity state 405 may comprise a “near to user” state in which the thermal policy manager 101 being executed by the CPU 110 and partially by the ADC controller 103 may monitor, poll, or receive one or more status reports on temperature from one or more thermal sensors 157, compare the status reports to a threshold temperature associated with an acceptable touch temperature of the device, and apply appropriate thermal management policies to maintain the touch temperature below the threshold. In this first policy state 405, the SAR module 26 may have received a signal from the proximity sensor 24 indicating that the PCD 100 is proximal to a user. Because the PCD 100 is near the user, the touch temperature threshold may be a primary determinant of user experience and, as such, the TPM 101 may implement thermal mitigation techniques that sacrifice QoS in favor of mitigating thermal energy generation.

The second proximity state 410 may comprise an “away from user” state in which the thermal policy manager 101 being executed by the CPU 110 and partially by the ADC controller 103 may monitor, poll, or receive one or more status reports on temperature from one or more thermal sensors 157, compare the status reports to a threshold temperature associated with an increased touch temperature of the device and apply appropriate thermal management policies to optimize performance without exceeding the adjusted touch temperature threshold. In this second policy state 410, the SAR module 26 may have received a signal from the proximity sensor 24 indicating that the PCD 100 is not proximal to a user. Because the PCD 100 is not near the user, the touch temperature threshold may be increased such that the primary determinant of user experience is the QoS subject to a modest increase in touch temperature. As such, the TPM 101 may implement thermal management techniques that increase the performance level of one or more components at the expense of increased thermal energy generation. Notably, in some embodiments, the increased touch temperature may be determined based on a level that allows for increased performance without generating so much thermal energy that the PCD 100 cannot dissipate energy at a reasonable rate for reentry into the first policy state.

The third proximity state 415 may comprise a “docked” state in which the thermal policy manager 101 being executed by the CPU 110 and partially by the ADC controller 103 may monitor, poll, or receive one or more status reports on temperature from one or more thermal sensors 157, compare the status reports to a threshold temperature associated with temperature operating limits of one or more components within the PCD 100, and apply appropriate thermal management policies to optimize performance without detrimentally effecting the PCD 100. In this third policy state 415, the SAR module 26 may have received a signal from the proximity sensor 24 indicating that the PCD 100 is not proximal to a user and/or confirmation that the PCD 100 has been received by an external docking device. Because the PCD 100 is not near the user and has been received into a docking device for the full leveraging of its performance capabilities, the touch temperature threshold may not be a significant driver of user experience. Rather, in the docked state, the primary driver of user experience may be the QoS subject only to operating temperatures that could damage the PCD 100. As such, the TPM 101 may implement thermal management techniques that substantially increase component performance at the expense of thermal energy generation.

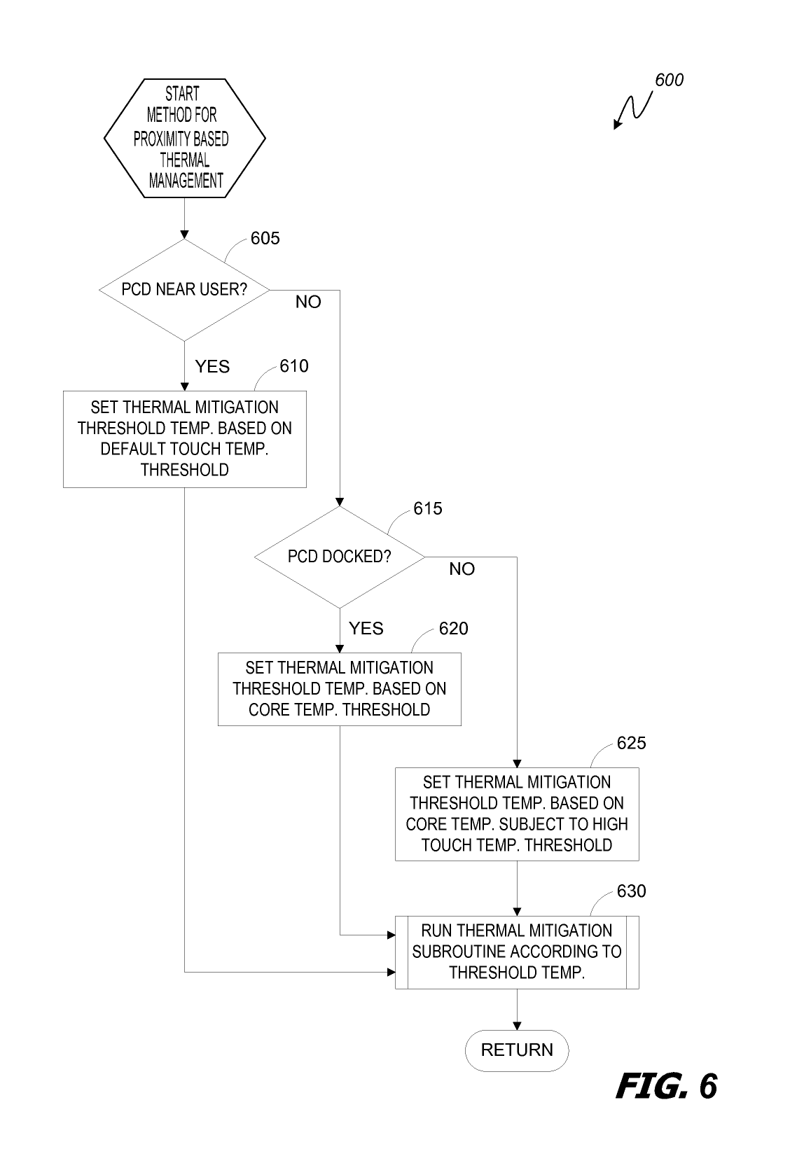

FIG. 6 is a logical flowchart illustrating a method 600 for leveraging user proximity as a trigger for applying thermal management policies within a PCD 100. Method 600 of FIG. 6 starts with a first decision block 605 in which the SAR module 26 may receive data representative of user proximity, or lack thereof, to the PCD 100. As has been described above, a proximity sensor 24 may be monitored by a monitor module 114 for signals representing user proximity to the device. The monitor module 114 may be in communication with the SAR module 26. If it is determined at decision block 605 that the PCD 100 is proximal to a user, the “yes” branch is followed to block 610. At block 610, the SAR module 26 may set, or leave unchanged, a temperature threshold at a level associated with an acceptable touch temperature of the PCD 100. In such a case, at block 630 the TPM module 101 may apply thermal mitigation techniques operable to maintain the touch temperature of the PCD 100 below the acceptable threshold.

If it is determined at decision block 605 that the PCD 100 is not proximal to a user, then the “no” branch is followed to decision block 615. At decision block 615, the SAR module 26 may determine if the PCD 100 is away from a user and/or received in a docking device. If it is determined that the PCD 100 is away from a user but not received into a docking device, then the “no” branch is followed to block 625. At block 625 the SAR module 26 may set a temperature threshold, for triggering thermal management policies, that allows one or more components to generate thermal energy at a rate that raises the touch temperature of the PCD 100 above the default threshold described above relative to block 610. Notably, at block 625 of the method, the temperature threshold set by the SAR module 26 may be subject to a condition that the touch temperature threshold does not exceed the default touch temperature threshold by such an amount that the PCD 100 cannot quickly cool to below the default touch temperature setting. At block 630, the TPM module 101 may apply thermal mitigation techniques operable to maintain the operating temperature of the PCD 100 below the acceptable threshold.

If at decision block 615, the SAR module 26 determines that the PCD 100 is not only away from the user but also received into a docking device for driving one or more external devices, the “yes” branch is followed to block 620. At block 620, the SAR module 26 may set the temperature threshold for application of thermal management policies at a relatively high operating temperature. Notably, when the PCD 100 is determined to be in a docked state, certain embodiments may assume that the touch temperature of the PCD 100 is not a primary driver of user experience and, as such, set a temperature threshold that allows the performance efficiency of one or more components within the PCD 100 to run at a rate that generates high levels of thermal energy. In some embodiments, it is envisioned that thermal management techniques implemented at block 630 may operate only to mitigate thermal energy generation that could potentially damage the PCD 100 while in other embodiments the temperature threshold set by the SAR module 26 when the PCD 100 is docked may still be subject to a maximum touch temperature threshold.

Concerning the application of thermal management techniques by the TPM module 101, one of ordinary skill in the art will recognize that systems and methods for triggering thermal management policies based on proximity and temperature measurements are not limited by the particular thermal management techniques that may or may not be triggered. Even so, thermal mitigation techniques that may be initiated by one or more embodiments include, but not limited to, (1) load scaling and/or (2) load dynamic scaling; (3) spatial load shifting; and (4) process load reallocation. Generally, thermal management techniques that include load scaling may comprise adjusting or “scaling” the maximum clock frequency allowed in DVFS algorithm. Advantageously, such an adjustment may limit the maximum heat dissipation. Thermal management techniques that include spatial load shifting and/or load reallocation include algorithms for distributing workloads within a given processing core or across multiple processing cores. In this way, thermal energy generation and dissipation may be managed by distributing the workload across a larger processing area, processing the workload in processing capacity associated with higher or lower power densities relative to initial allocation, or leveraging underutilized processing components to perform as heat sinks

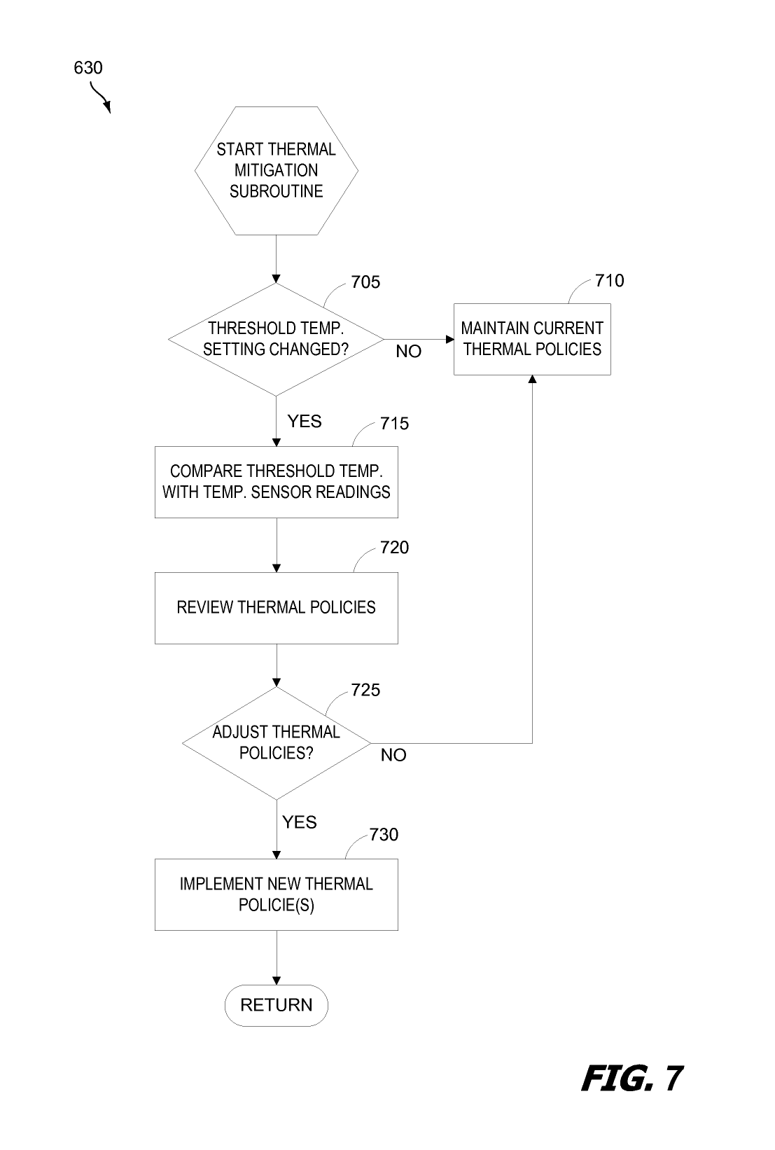

FIG. 7 is a logical flowchart illustrating an exemplary, non-limiting sub-method or subroutine 630 for applying thermal management policies. The method 630 of FIG. 7 starts with decision block 705. At block 705, the TPM module 101 may determine whether the SAR module 26 has changed the threshold temperature for triggering thermal management policies. Notably, as has been described throughout this disclosure, the SAR module 26 may not only change or set a threshold temperature, but may also change or determine an aspect within the PCD 100 that is associated with the threshold temperature. For instance, as has been described above, the threshold temperature determined by the SAR module 26, and used by the TPM module 101 to trigger thermal management policy, may be associated with any number of aspects within the PCD 100 including, but not limited to, a processing component (i.e., operating temperature of the component), the external temperature of the PCD 100 (i.e., the touch temperature of the device) or a cascaded logic that includes a first threshold temperature measured by a first sensor subject to a second threshold temperature measured by a second sensor.

If the TPM module 101 determines at decision block 705 that the threshold temperature has not been changed by the SAR module 26, then the presently implemented thermal management policies may be maintained by the TPM module 101. If, however, at decision block 705 the TPM module 101 recognizes a change in the temperature threshold and/or the sensor that is monitored for the temperature threshold, the “yes” branch is followed to block 715. At block 715, the TPM module 101 may compare the newly set temperature threshold to the actual temperature measured at an associated sensor such as, for example, sensors 157A or 157B. Based on the comparison, the TPM module 101 may review the currently implemented thermal management policies, if any, at block 720 and decide at decision block 725 whether the currently implement thermal management policies require adjustment. If at decision block 725 the TPM module 101 determines that no adjustment or modification of thermal management policies is warranted in light of the block 715 comparison, the “no” branch is followed back to block 710 and the current policies are maintained. If, however, at decision block 725 the TPM module 101 determines that a change or modification of thermal management policies is warranted, the “yes” branch is followed to block 730 and the TPM module 101 may elect to implement one or more alternative thermal management techniques.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for managing thermal energy generation in a portable computing device (“PCD”), the method comprising:
monitoring a proximity signal from a proximity sensor in the PCD, wherein the proximity signal represents relative physical proximity of the PCD to a user;
based on the monitored proximity signal, setting a first temperature threshold for triggering initiation of one or more thermal management policies, wherein the first temperature threshold is associated with a first temperature sensor in the PCD;
comparing the first temperature threshold with a temperature measurement received from the first temperature sensor; and
based on the comparison, evaluating the applicability of currently implemented thermal management policies.

2. The method of claim 1, further comprising:
electing to continue application of currently implemented thermal management policies.

3. The method of claim 1, further comprising:
electing to modify the currently implemented thermal management policies.

4. The method of claim 1, wherein the proximity signal indicates that the PCD is proximal to a user.

5. The method of claim 4, wherein the first temperature threshold is associated with the touch temperature of the PCD.

6. The method of claim 1, wherein the proximity signal indicates that the PCD is not physically proximal to a user.

7. The method of claim 6, wherein the first temperature threshold is associated with the operating temperature of a processing component in the PCD.

8. The method of claim 7, further comprising:
setting a second temperature threshold that is associated with a second temperature sensor in the PCD;
comparing the second temperature threshold with a temperature measurement received from the second temperature sensor; and
based on the comparison of the first temperature threshold with the temperature measurement received from the first temperature sensor, electing to modify the currently implemented thermal management policies;
wherein the modified thermal management policies prevent the second temperature sensor measurement from exceeding the second temperature sensor threshold.

9. The method of claim 1, wherein the proximity signal indicates that the PCD is received into a docking device.

10. The method of claim 9, wherein the first temperature threshold is associated with the maximum operating temperature of a processing component in the PCD.

11. A computer system for managing thermal energy generation in a portable computing device (“PCD”), the system comprising:
a specific absorption rate (“SAR”) module, configured to:
monitor a proximity signal from a proximity sensor in the PCD, wherein the proximity signal represents relative physical proximity of the PCD to a user; and
based on the monitored proximity signal, set a first temperature threshold for triggering initiation of one or more thermal management policies, wherein the first temperature threshold is associated with a first temperature sensor in the PCD; and
a thermal policy manager (“TPM”) module, configured to:
compare the first temperature threshold with a temperature measurement received from the first temperature sensor; and
based on the comparison, evaluate the applicability of currently implemented thermal management policies.

12. The computer system of claim 11, wherein the TPM module is further configured to:
elect to continue application of currently implemented thermal management policies.

13. The computer system of claim 11, wherein the TPM module is further configured to:
elect to modify the currently implemented thermal management policies.

14. The computer system of claim 11, wherein the proximity signal indicates that the PCD is proximal to a user.

15. The computer system of claim 14, wherein the first temperature threshold is associated with the touch temperature of the PCD.

16. The computer system of claim 11, wherein the proximity signal indicates that the PCD is not physically proximal to a user.

17. The computer system of claim 16, wherein the first temperature threshold is associated with the operating temperature of a processing component in the PCD.

18. The computer system of claim 17, wherein:
the SAR module is further configured to:
set a second temperature threshold that is associated with a second temperature sensor in the PCD; and
the TPM module is further configured to:
compare the second temperature threshold with a temperature measurement received from the second temperature sensor; and
based on the comparison of the first temperature threshold with the temperature measurement received from the first temperature sensor, elect to modify the currently implemented thermal management policies;
wherein the modified thermal management policies prevent the second temperature sensor measurement from exceeding the second temperature sensor threshold.

19. The computer system of claim 11, wherein the proximity signal indicates that the PCD is received into a docking device.

20. The computer system of claim 19, wherein the first temperature threshold is associated with the maximum operating temperature of a processing component in the PCD.

21. A computer system for managing thermal energy generation in a portable computing device, the system comprising:
means for monitoring a proximity signal from a proximity sensor in the PCD, wherein the proximity signal represents relative physical proximity of the PCD to a user;
based on the monitored proximity signal, means for setting a first temperature threshold for triggering initiation of one or more thermal management policies, wherein the first temperature threshold is associated with a first temperature sensor in the PCD;
means for comparing the first temperature threshold with a temperature measurement received from the first temperature sensor; and
based on the comparison, means for evaluating the applicability of currently implemented thermal management policies.

22. The computer system of claim 21, further comprising:
means for electing to continue application of currently implemented thermal management policies.

23. The computer system of claim 21, further comprising:
means for electing to modify the currently implemented thermal management policies.

24. The computer system of claim 21, wherein the proximity signal indicates that the PCD is proximal to a user.

25. The computer system of claim 24, wherein the first temperature threshold is associated with the touch temperature of the PCD.

26. The computer system of claim 21, wherein the proximity signal indicates that the PCD is not physically proximal to a user.

27. The computer system of claim 26, wherein the first temperature threshold is associated with the operating temperature of a processing component in the PCD.

28. The computer system of claim 27, further comprising:
means for setting a second temperature threshold that is associated with a second temperature sensor in the PCD;
means for comparing the second temperature threshold with a temperature measurement received from the second temperature sensor; and
based on the comparison of the first temperature threshold with the temperature measurement received from the first temperature sensor, means for electing to modify the currently implemented thermal management policies;
wherein the modified thermal management policies prevent the second temperature sensor measurement from exceeding the second temperature sensor threshold.

29. The computer system of claim 21, wherein the proximity signal indicates that the PCD is received into a docking device.

30. The computer system of claim 29, wherein the first temperature threshold is associated with the maximum operating temperature of a processing component in the PCD.

31. A computer program product comprising a computer usable medium having a computer readable program code embodied therein, said computer readable program code adapted to be executed to implement a method for managing thermal energy generation in a portable computing device, said method comprising:
monitoring a proximity signal from a proximity sensor in the PCD, wherein the proximity signal represents relative physical proximity of the PCD to a user;
based on the monitored proximity signal, setting a first temperature threshold for triggering initiation of one or more thermal management policies, wherein the first temperature threshold is associated with a first temperature sensor in the PCD;
comparing the first temperature threshold with a temperature measurement received from the first temperature sensor; and
based on the comparison, evaluating the applicability of currently implemented thermal management policies.

32. The computer program product of claim 31, further comprising:
electing to continue application of currently implemented thermal management policies.

33. The computer program product of claim 31, further comprising:
electing to modify the currently implemented thermal management policies.

34. The computer program product of claim 31, wherein the proximity signal indicates that the PCD is proximal to a user.

35. The computer program product of claim 34, wherein the first temperature threshold is associated with the touch temperature of the PCD.

36. The computer program product of claim 31, wherein the proximity signal indicates that the PCD is not physically proximal to a user.

37. The computer program product of claim 36, wherein the first temperature threshold is associated with the operating temperature of a processing component in the PCD.

38. The computer program product of claim 37, further comprising:
setting a second temperature threshold that is associated with a second temperature sensor in the PCD;
comparing the second temperature threshold with a temperature measurement received from the second temperature sensor; and
based on the comparison of the first temperature threshold with the temperature measurement received from the first temperature sensor, electing to modify the currently implemented thermal management policies;
wherein the modified thermal management policies prevent the second temperature sensor measurement from exceeding the second temperature sensor threshold.

39. The computer program product of claim 31, wherein the proximity signal indicates that the PCD is received into a docking device.

40. The computer program product of claim 39, wherein the first temperature threshold is associated with the maximum operating temperature of a processing component in the PCD.
